(19) United States
(12) Patent Application Publication
(10) Pub. No.: US 2011/0317999 A1
(43) Pub. Date: Dec. 29, 2011

(54) WAVELENGTH DIVISION MULTIPLEX DEVICE, WAVELENGTH DIVISION MULTIPLEX TRANSMISSION SYSTEM, AND WAVELENGTH MULTIPLEX SIGNAL CONTROL METHOD

(75) Inventor: Hiroaki Tanaka, Tokyo (JP)

(73) Assignee: NEC CORPORATION, Minato-ku, Tokyo (JP)

(21) Appl. No.: 13/254,122

(22) PCT Filed: Dec. 25, 2009
(86) PCT No.: PCT/JP2009/007299

§ 371 Date: Aug. 31, 2011

(30) Foreign Application Priority Data
Mar. 19, 2009 (JP) 2009-067354

(51) Int. Cl. H04B 10/08

(52) U.S. Cl. 398/34

(57) ABSTRACT

To provide a wavelength division multiplex device capable of detecting an abnormality in counting of a wavelength number of a wavelength multiplex signal transmitted and received between two opposing devices. When a comparison result of a wavelength number information comparison unit 9 shows a match between a received wavelength number obtained by counting the wavelength number of the wavelength multiplex signal from an opposing device by a received wavelength number counting unit 8, and a transmitted wavelength number of the wavelength multiplex signal extracted from a monitoring light signal from the opposing device by a monitoring light reception unit 7, the transmitted wavelength number is updated and stored in a receiving-side memory as a latest transmitted wavelength number; an output level of a wavelength multiplex signal of a reception light amplifier 5 is controlled based on the transmitted wavelength number; and OK flag indicating a match to the opposing device of a transmission source of the wavelength multiplex signal. When the both do not match, the output level of the wavelength multiplex signal of the reception light amplifier 5 is controlled based not on the transmitted wavelength number but on the latest transmitted wavelength number updated and stored in the receiving-side memory, and NG flag indicating a mismatch is returned to the opposing device of the transmission source of the wavelength multiplex signal.

### TECHNICAL FIELD

The present invention relates to a wavelength division multiplex device, a wavelength division multiplex transmission system, and a wavelength multiplex signal control method.

### BACKGROUND ART

In a wavelength division multiplex (WDM) transmission system, it is necessary to appropriately control an output level of a light amplifier according to the number of multiplexed wavelengths, as disclosed in Patent Literature 1 (Japanese Unexamined Patent Application Publication No. 2004-147122 “OPTICAL WAVELENGTH MULTIPLEXING NETWORK AND REMOTE NODE THEREOF”). Therefore, the function of counting the number of multiplexed wavelengths is important.

FIG. 3 shows a typical system for counting the number of wavelengths and transferring the wavelength number. FIG. 3 is an explanatory diagram illustrating a mechanism for counting the number of wavelengths and transferring the wavelength number in a wavelength division multiplex transmission system disclosed as a related art of the present invention. FIG. 3 shows a system configuration of a wavelength division multiplex transmission system (WDM transmission system) in which two opposing wavelength division multiplex devices of an opposing device located on an upstream side, i.e., an upstream node 10A, and an opposing device located on a downstream side, i.e., a downstream node 20A, are connected via a transmission path 30.

As shown in FIG. 3, the opposing device located on the upstream side, i.e., the upstream node 10A, includes at least a transmission light amplifier 31, a multiplexing unit 34, a monitoring light transmission unit 35, and a wavelength number counting unit 36. The opposing device located at the downstream side, i.e., the downstream node 20, includes at least a reception light amplifier 45, a demultiplexing unit 46, and a monitoring light reception unit 47. The upstream node 10A and the downstream node 20A are connected via a transmission path 48. In FIG. 3, a heavy-line arrow indicates a wavelength multiplex signal; a dotted-line arrow indicates a monitoring light signal; and a double-line arrow indicates wavelength number information.

On the transmitting side of the upstream node 10A, the wavelength number counting unit 36 counts the number of wavelengths of a wavelength multiplex signal (main signal) output from the transmission light amplifier 33. The wavelength number counting unit 36 then transmits counted wavelength number information to be used for controlling the output level of the wavelength multiplex signal of the transmission light amplifier 33, for example, and transfers the wavelength number information to the monitoring light transmission unit 35. The monitoring light transmission unit 35 incorporates the received wavelength number information into a monitoring light signal. The multiplexing unit 34 multiplexes the main signal from the transmission light amplifier 33 with the monitoring light signal from the monitoring light transmission unit 35, and transmits a wavelength multiplex signal, which is obtained by multiplexing the main signal with the monitoring light signal, to the downstream node 20A via the transmission path 48.

In the downstream node 20A, the demultiplexing unit 46 demultiplexes the wavelength multiplex signal into the main signal and the monitoring light signal, and transfers the monitoring light signal to the monitoring light reception unit 47. The monitoring light reception unit 47 extracts the wavelength number information from the received monitoring light signal, and transfers the extracted wavelength number information to the reception light amplifier 45. The reception light amplifier 45 uses the wavelength number information received from the monitoring light reception unit 47, and controls the output level of the wavelength multiplex signal, for example.

### CITATION LIST

### Patent Literature

[Patent Literature 1] Japanese Unexamined Patent Application Publication No. 2004-147122 (pp. 4-9)

### SUMMARY OF INVENTION

### Technical Problem

However, the wavelength division multiplex transmission system (WDM transmission system) of the related art as shown in FIG. 3 has a problem to be solved as described below. That is, if the counted wavelength number is abnormal due to a failure of the wavelength number counting unit 36 in the upstream node 10A, incorrect wavelength number information is transferred to the downstream node 20A. This may cause a malfunction of the reception light amplifier 45.

The present invention has been made in view of the above-mentioned problem, and an object of the present invention is to provide a wavelength division multiplex device, a wavelength division multiplex transmission system, and a wavelength multiplex signal control method in order to solve the problem of a control error of the light amplifier due to a failure of the wavelength number counting unit.

### Solution to Problem

In order to solve the above-mentioned problem, a wavelength division multiplex device, a wavelength division multiplex transmission system, and a wavelength multiplex signal control method according to the present invention have the following characteristic features. The following items (1), (5), (11), (12), and (16) respectively correspond to the numbers of claims of the present invention.

(1) A wavelength division multiplex device including: received wavelength number counting means for counting the number of wavelengths of a main signal of a received wavelength multiplex signal as a received wavelength number; monitoring light receiving means for extracting information on a transmitted wavelength number from a monitoring light signal superimposed on the received wavelength multiplex signal; and wavelength number information comparison means for comparing the transmitted wavelength number with the received wavelength number.

(5) A wavelength division multiplex device including monitoring light receiving means for extracting a flag indicating a mismatch between a transmitted wavelength number transmitted by an own device and a received wavelength number received by a reception device, from monitoring light superimposed on a received wavelength multiplex signal, in which upon the extraction of the flag by the monitoring light receiving means, an output level of a wavelength multiplex signal to be transmitted is controlled based on a transmitted wavelength number obtained immediately before the extraction of the flag.

(11) A wavelength division multiplex transmission system including wavelength division multiplex devices set forth in any one of the items (1) to (9), in which a wavelength multiplex signal is transmitted between the wavelength division multiplex devices.

(12) A wavelength multiplex signal control method including: counting the number of wavelengths of a main signal of a received wavelength multiplex signal as a received wavelength number; extracting information on a transmitted wavelength number from a monitoring light signal superimposed on the received wavelength multiplex signal; comparing the received wavelength number with the transmitted wavelength number; and using a result of the comparison to control the received wavelength multiplex signal.

(16) A wavelength multiplex signal control method including: extracting a flag indicating a mismatch between a transmitted wavelength number transmitted by the own device and a received wavelength number received by a reception device, from monitoring light superimposed on a received wavelength multiplex signal; and controlling, upon extraction of the flag, an output level of a wavelength multiplex signal to be transmitted, based on a transmitted wavelength number obtained immediately before the extraction of the flag.

### Advantageous Effects of Invention

According to a wavelength division multiplex device, a wavelength division multiplex transmission system, and a wavelength multiplex signal control method of the present invention, the following advantageous effects can be obtained.

In a plurality of opposing wavelength division multiplex devices, transmitted wavelength number information from an upstream node and received wavelength number information detected by a downstream node are compared, thereby making it possible to detect occurrence of an abnormality in counting means in the upstream node or the downstream node.

### BRIEF DESCRIPTION OF DRAWINGS

FIG. 1 is a device configuration diagram showing an exemplary device configuration of a wavelength division multiplex device according to the present invention;

FIG. 2 is an explanatory diagram illustrating a mechanism for counting the number of wavelengths and transferring the wavelength number in a wavelength division multiplex transmission system according to the present invention; and

FIG. 3 is an explanatory diagram illustrating a mechanism for counting the number of wavelengths and transferring the wavelength number in a wavelength division multiplex transmission system of a related art.

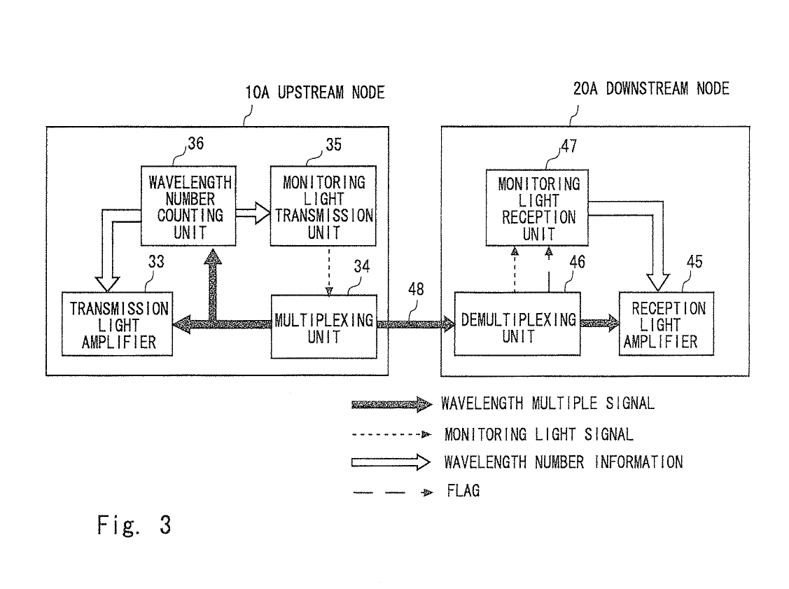

### DESCRIPTION OF EMBODIMENTS

Exemplary embodiments of a wavelength division multiplex device, a wavelength division multiplex transmission system, and a wavelength multiplex signal control method according to the present invention will be described below with reference to the accompanying drawings.

### (Features of the Present Invention)

Features of the present invention will be described prior to describing exemplary embodiments of the present invention. According to the present invention, in a wavelength division multiplex (WDM) transmission system, wavelength division multiplex devices constituting the wavelength division multiplex transmission system are capable of comparing information on a wavelength number transferred from an opposing device with information on a wavelength number counted in the own device. Further, when a mismatch occurs, the output level of a wavelength multiplex signal, for example, can be controlled using the latest (most recent) wavelength number information stored.

That is, according to the present invention, in two wavelength division multiplex devices, which are located on the upstream side and the downstream side so as to oppose to each other, a downstream node is also provided with a wavelength number detecting function, which enables comparison between wavelength number information (transmitted wavelength number information) transmitted from an upstream node and wavelength number information (received wavelength number information) detected from a wavelength multiplex signal received by the downstream node itself. This makes it possible to detect an abnormality of a wavelength number counting unit in the downstream node or the upstream node. When the comparison result shows a match, the output level of a light amplifier, for example, is controlled based on new matching wavelength number information. In the case of a mismatch, a wavelength number mismatch alarm is notified from the downstream node to the upstream node, and each of the upstream node and the downstream node controls the light amplifier based on the latest (most recent) wavelength number, i.e., the latest wavelength number information. This prevents the occurrence of a control error of a transmission light amplifier or a reception light amplifier in the upstream node or the downstream node.

### (Exemplary Configuration of Exemplary Embodiment)

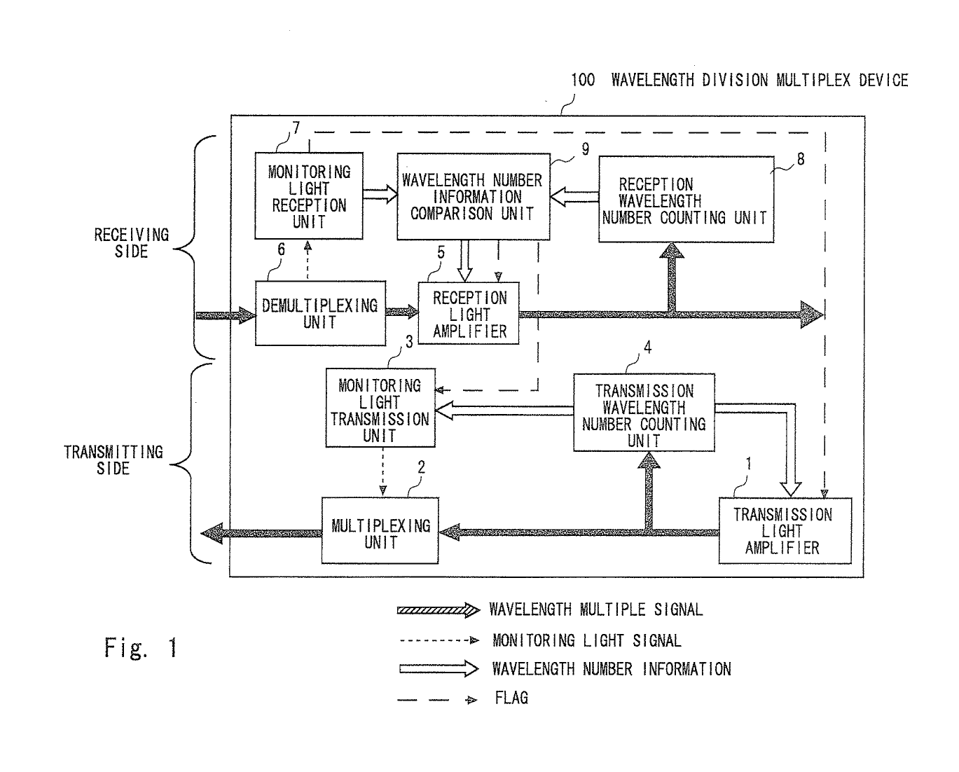

FIG. 1 is a device configuration diagram showing an exemplary deice configuration of a wavelength division multiplex device according to the present invention. FIG. 1 illustrates parts associated with wavelength number information and also shows a configuration example of each part associated with the detection of an abnormality in counting the number of wavelengths and the protection of a normal operation of a light amplifier during detection of an abnormality. In a wavelength division multiplex device 100 shown in FIG. 1, receiving-side circuits are disposed at the upper side of FIG. 1, and transmitting-side circuits are disposed at the lower side of FIG. 1.

As shown in FIG. 1, the transmitting-side circuits of the wavelength division multiplex device 100 include at least a transmission light amplifier 1, a multiplexing unit 2, a monitoring light transmission unit 3, and a transmitted wavelength number counting unit 4. The receiving-side circuits of the wavelength division multiplex device 100 include at least a reception light amplifier 5, a demultiplexing unit 6, a monitoring light reception unit 7, a received wavelength number counting unit 8, and a wavelength number information comparison unit 9. In FIG. 1, a heavy-line arrow indicates a wavelength multiplex signal; a dotted-line arrow indicates a monitoring light signal; a double-line arrow indicates wavelength number information; and a dashed-line arrow indicates a flag (information).

That is, on the transmitting side of the wavelength division multiplex device 100, the transmission light amplifier 1 is a circuit that amplifies and outputs the wavelength multiplex signal (main signal) to be sent out to the opposing wavelength division multiplex device, i.e., the opposing node. The multiplexing unit 2 is a circuit that multiplexes the main signal from the transmission light amplifier 1 with the monitoring light signal from the monitoring light transmission unit 3, and outputs the wavelength multiplex signal including the main signal and the monitoring light signal to the opposing wavelength division multiplex device, i.e., the opposing node. The monitoring light transmission unit 3 is a circuit that generates the monitoring light signal including at least wavelength number information on the transmitted wavelength number and a flag from the wavelength number information comparison unit 9 on the transmitting side so that the monitoring light signal is transmitted to the opposing wavelength division multiplex device, i.e., the opposing node. The transmission light amplifier 1 is a circuit that outputs the wavelength multiplex signal (main signal) to be transmitted to the opposing wavelength division multiplex device, i.e., the opposing node. The transmitted wavelength number counting unit 4 is a circuit that counts the number of wavelengths of the wavelength multiplex signal (main signal).

Here, the wavelength multiplex signal (main signal) output from the transmission light amplifier 1 is input to each of the multiplexing unit 2 and the transmitted wavelength number counting unit 4. The transmitted wavelength number information output from the transmitted wavelength number counting unit 4 is input to each of the transmission light amplifier 1 and the monitoring light transmission unit 3. The monitoring light signal output from the monitoring light transmission unit 3 is input to the multiplexing unit 2. The multiplexing unit 2 multiplexes the wavelength multiplex signal (main signal), which is an output of the transmission light amplifier 1, with the monitoring light signal, which is an output of the monitoring light transmission unit 3, and outputs the wavelength multiplex signal including the main signal and the monitoring light signal to a transmission path leading to the opposing node. The output level of the transmission light amplifier 1, for example, is controlled based not only on the transmitted wavelength number information output from the transmitted wavelength number counting unit 4, but also on the flag output from the monitoring light reception unit 7 on the receiving side.

On the other hand, on the receiving side of the wavelength division multiplex device 100, the demultiplexing unit 6 is a circuit that receives the wavelength multiplex signal (including the main signal and the monitoring light signal) from the opposing wavelength division multiplex device, i.e., the opposing node, and demultiplexes the signal into the main signal (wavelength multiplex signal) and the monitoring light signal to be respectively output to the reception light amplifier 5 and the monitoring light reception unit 7. The reception light amplifier 5 is a circuit that amplifies the wavelength multiplex signal (main signal) received from the opposing wavelength division multiplex device, i.e., the opposing node through the demultiplexing unit 6. The monitoring light reception unit 7 is a circuit that receives the monitoring light signal, and extracts at least a flag and transmitted wavelength number information from the opposing wavelength division multiplex device, i.e., the opposing node. The received wavelength number counting unit 8 is a circuit that counts the number of wavelengths (received wavelength number) of the wavelength multiple signal (main signal) which is received by the demultiplexing unit 6 and amplified by the reception light amplifier 5. The wavelength number information comparison unit 9 is a circuit that compares the transmitted wavelength number information extracted by the monitoring light reception unit 7 with the received wavelength number information detected by the received wavelength number counting unit 8 in the own node.

In this way, the signal from the opposing wavelength division multiplex device, i.e., the opposing node, is received by the demultiplexing unit 6. The monitoring light signal demultiplexed by the demultiplexing unit 6 is input to the monitoring light reception unit 7. The wavelength multiplex signal (main signal) demultiplexed by the demultiplexing unit 6 is input to the reception light amplifier 5. The output of the flag extracted from the monitoring light signal by the monitoring light reception unit 7 is input to the transmission light amplifier 1. The output of the transmitted wavelength number information extracted from the monitoring light signal by the monitoring light reception unit 7 is input to the wavelength number information comparison unit 9.

The transmitted wavelength number information received by the wavelength number information comparison unit 9 is also directly input to the reception light amplifier 5. Further, the output of the flag indicating the comparison result of the wavelength number information output from the wavelength number information comparison unit 9 is input to each of the reception light amplifier 5 and the monitoring light transmission unit 3 on the transmitting side.

The wavelength multiplex signal (main signal) output from the reception light amplifier 5 is input to the received wavelength number counting unit 8 and is also sent to a main signal processing circuit at a subsequent stage. The output of the received wavelength number information from the received wavelength number counting unit 8 is input to the wavelength number information comparison unit 9.

### (Description of Operation of Exemplary Embodiment)

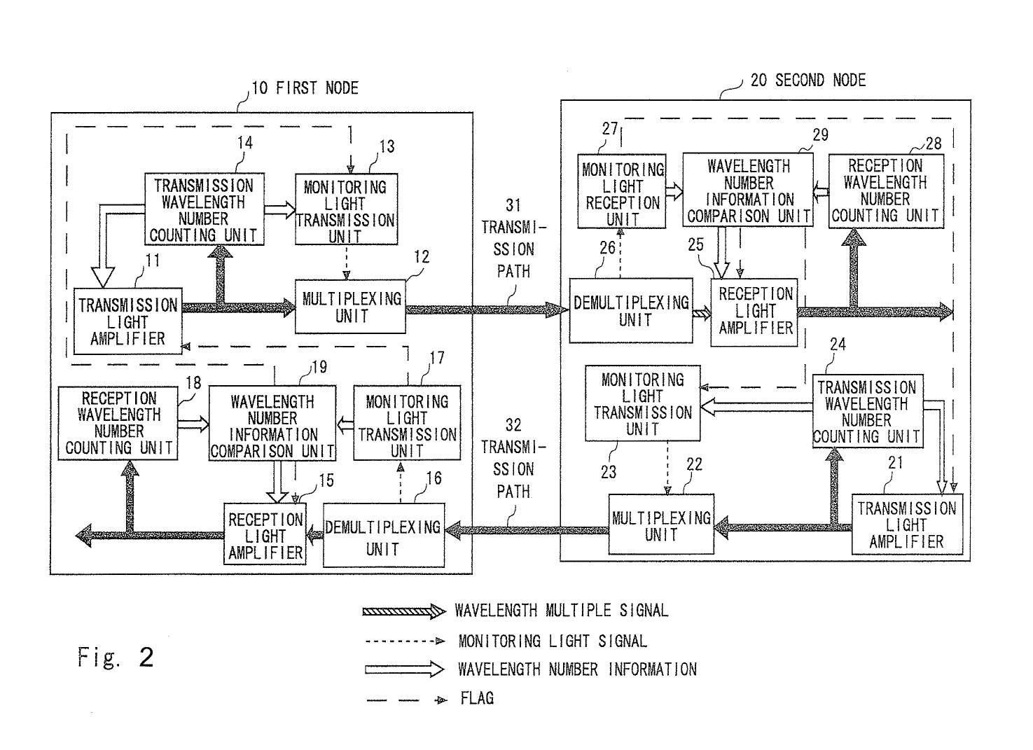

Next, an exemplary operation of the wavelength division multiplex device (WDM device) 100 of FIG. 1 which shows an exemplary embodiment of the present invention will be described with reference to FIG. 2.

FIG. 2 is an explanatory diagram illustrating a mechanism for counting the number of wavelengths and transferring the wavelength number in the wavelength division multiplex transmission system of the present invention. FIG. 2 shows a system configuration of the wavelength division multiplex transmission system in which a first node 10 and a second node 20, each of which includes the wavelength division multiplex device shown in FIG. 1, are connected via transmission paths 31 and 32.

As shown in FIG. 2, as with the wavelength division multiplex device 100 shown in FIG. 1, the first node 10 includes at least, as transmitting-side circuits, a transmission light amplifier 11, a multiplexing unit 12, a monitoring light transmission unit 13, and a transmitted wavelength number counting unit 14, and also includes at least, as receiving-side circuits, a reception light amplifier 15, a demultiplexing unit 16, a monitoring light reception unit 17, a received wavelength number counting unit 18, and a wavelength number information comparison unit 19.

On the other hand, as with the first node 10, the second node 20 includes at least, as transmitting-side circuits, a transmission light amplifier 21, a multiplexing unit 22, a monitoring light transmission unit 23, and a transmitted wavelength number counting unit 24, and also includes at least, as receiving-side circuits, a reception light amplifier 25, a demultiplexing unit 26, a monitoring light reception unit 27, a received wavelength number counting unit 28, and a wavelength number information comparison unit 29.

The multiplexing unit 12 of the first node 10 and the demultiplexing unit 26 of the second node 20 are connected via the transmission path 31. Meanwhile, the multiplexing unit 22 of the second node 20 and the demultiplexing unit 16 of the first node 10 are connected via the transmission path 32. In FIG. 2, a heavy-line arrow indicates a wavelength multiplex signal; a dotted-line arrow indicates a monitoring light signal; a double-line arrow indicates wavelength number information; and a dashed-line arrow indicates a flag.

Referring to FIG. 2, the transmitted wavelength number counting unit 14 of the first node 10 counts the number of wavelengths of a wavelength multiplex signal (main signal) output from the transmission light amplifier 11, and transfers the count result as transmitted wavelength number information to each of the transmission light amplifier 11 and the monitoring light transmission unit 13. The monitoring light transmission unit 13 incorporates the transferred transmitted wavelength number information into a monitoring light signal, and outputs it to the multiplexing unit 12. The multiplexing unit 12 multiplexes the monitoring light received from the monitoring light transmission unit 13 with the wavelength multiplex signal (main signal) received from the transmission light amplifier 11, and outputs the wavelength multiplex signal obtained by multiplexing the monitoring light signal with the main signal to the second node 20 through the transmission path 31.

In the second node 20, the demultiplexing unit 26 receives the wavelength multiplex signal (including the main signal and the monitoring light signal) from the first node 10. The demultiplexing unit 26 demultiplexer the received signal into the monitoring light signal and the main signal (wavelength multiplex signal) to be respectively output to the monitoring light reception unit 27 and the reception light amplifier 25. The monitoring light reception unit 27 extracts the transmitted wavelength number information which is received from the first node 10 and is included in the monitoring light signal from the demultiplexing unit 26, and outputs the transmitted wavelength number information to the wavelength number information comparison unit 29. The reception light amplifier 25 receives the wavelength multiplex signal (main signal) from the demultiplexing unit 26, amplifies the wavelength multiplex signal (main signal) according to the output level controlled based on the transmitted wavelength number information from the wavelength number information comparison unit 29 or the latest (most recent) transmitted wavelength number information held in a receiving-side memory within the reception light amplifier 25, and outputs the amplified wavelength multiplex signal. Here, the reception light amplifier 25 selects one of the transmitted wavelength number information from the wavelength number information comparison unit 29 and the latest (most recent) transmitted wavelength number information held in the receiving-side memory within the reception light amplifier 25, depending on the state of the flag output from the wavelength number information comparison unit 29, and uses the selected information as the wavelength number information for controlling the output level or the like. The received wavelength number counting unit 28 counts the number of wavelengths of the wavelength multiplex signal (main signal) amplified by the reception light amplifier 25, and outputs the count result as the received wavelength number information to the wavelength number information comparison unit 29.

The wavelength number information comparison unit 29 of the second node 20 compares the transmitted wavelength number information (transmitted wavelength number information from the monitoring light reception unit 27) received from the opposing node, i.e., the first node 10, with the received wavelength number information detected by the received wavelength number counting unit 28 of the own node, and performs the following processing.

(1) <In the Case of a Match between the Transmitted Wavelength Number Information and the Received Wavelength Number Information>

As a flag indicating a match as a comparison result between the transmitted wavelength number information and the received wavelength number information, “OK flag” is output from the wavelength number information comparison unit 29 to each of the reception light amplifier 25 and the monitoring light transmission unit 23. Further, the transmitted wavelength number information that matches the received wavelength number information is output to the reception light amplifier 25.

(2) <In the Case of a Mismatch between the Transmitted Wavelength Number Information and the Received Wavelength Number Information>

As a flag indicating a mismatch as a comparison result between the transmitted wavelength number information and the received wavelength number information, “NG flag” is output from the wavelength number information comparison unit 29 to each of the reception light amplifier 25 and the monitoring light transmission unit 23.

The reception light amplifier 25 having received the flag (“OK flag” or “NG flag”) and the transmitted wavelength number information (transmitted wavelength number information obtained when the transmitted wavelength number information matches the received wavelength number information) as described above from the wavelength number information comparison unit 29 of the second node 20 performs the following processing.

(a) <In the Case where “OK Flag” is Received from the Wavelength Number Information Comparison Unit 29>

Determining that the transmitted wavelength number information received from the wavelength number information comparison unit 29 is normal, the reception light amplifier 25 uses the transmitted wavelength number information for controlling updating of the value of, for example, the output level of the reception light amplifier 25. Further, the reception light amplifier 25 overwrites the transmitted wavelength number information with the transmitted wavelength number information stored in the receiving-side memory within the reception light amplifier 25, as the latest (most recent) transmitted wavelength number information matching the received wavelength number information, thereby updating the transmitted wavelength number information and storing it again.

(b) <In the Case where “NG Flag” is Received from the Wavelength Number Information Comparison Unit 29>

Determining that abnormality occurs in the transmitted wavelength number information received from the opposing node, i.e., the first node 10, or in the received wavelength number information counted by the received wavelength number counting unit 28 of the own node, i.e., the second node 20, the reception light amplifier 25 uses, instead of the transmission wavelength information, the transmitted wavelength number information stored in the receiving-side memory within the reception light amplifier 25 as the latest transmitted wavelength number information obtained when the transmitted wavelength number information matches the received wavelength number information. That is, the reception light amplifier 25 retains the latest value and does not update the value of, for example, the output level of the reception light amplifier 25. Further, the reception light amplifier 25 sends to a user an alarm indicating reception of “NG flag”, i.e., an alarm indicating a mismatch between the received wavelength number in the own node, i.e., the second node 20, and the transmitted wavelength number in the opposing node, i.e., the first node 10.

When the alarm indicating “NG flag” is sent from the reception light amplifier 25, it is assumed that failure has occurred in the received wavelength number counting unit 28 of the own node, i.e., the second node 20, or in the transmitted wavelength number counting unit 14 of the opposing node, i.e., the first node 10. Accordingly, the user performs a maintenance operation such as replacement of the received wavelength number counting unit 28 in the second node 20 or the transmitted wavelength number counting unit 14 in the first node 10.

Furthermore, the monitoring light transmission unit 23 having received “OK flag” or “NG flag” from the wavelength number information comparison unit 29 incorporates the received “OK flag” or “NG flag” into the monitoring light signal. The multiplexing unit 22 multiplexes the monitoring light signal received from the monitoring light transmission unit 23 with the wavelength multiplex signal (main signal) received from the transmission light amplifier 21, and transmits the wavelength multiplex signal including the monitoring light signal and the main signal to the first node 10 through the transmission path 32.

In the first node 10, the demultiplexing unit 16 receives the wavelength multiplex signal (including the main signal and the monitoring light signal) from the second node 20. The demultiplexing unit 16 demultiplexes the received signal into the monitoring light signal and the wavelength multiplex signal (main signal) to be respectively output to the monitoring light reception unit 17 and the reception light amplifier 15.

The monitoring light reception unit 17 receives the monitoring light signal demultiplexed from the wavelength multiplex signal by the demultiplexing unit 16 of the first node 10. The monitoring light reception unit 17 extracts “OK flag” or “NG flag” from the second node 20, in addition to the transmitted wavelength number information, which is received from the second node 20 and included in the received monitoring light signal, and outputs the extracted transmitted wavelength number information to the wavelength number information comparison unit 19. Further, the monitoring light reception unit 17 transfers the extracted “OK flag” or “NG flag” to the transmission light amplifier 11.

The transmission light amplifier 11 having received “OK flag” or “NG flag” from the monitoring light reception unit 17 performs the following processing.

(a) <In the Case where “OK Flag” is Received from the Monitoring Light Reception Unit 17>

Determining that the transmitted wavelength number information received from the transmitted wavelength number counting unit 14 is normal, the transmission light amplifier 11 uses the transmitted wavelength number information for controlling updating of the value of, for example, the output level of the transmission light amplifier 11. Further, the transmission light amplifier 11 overwrites the transmitted wavelength number information with the transmitted wavelength number information stored in a transmitting-side memory within the transmission light amplifier 11, as the latest (most recent) transmitted wavelength number information matching the received wavelength number information in the opposing node, i.e., the second node 20, thereby updating the transmitted wavelength number information and storing it again.

(b) <In the Case where “NG Flag” is Received from the Monitoring Light Reception Unit 17>

Determining that abnormality occurs in the transmitted wavelength number information from the transmitted wavelength number counting unit 14, or in the received wavelength number information in the opposing node, i.e., the second node 20, the transmission light amplifier 11 uses, instead of the transmission wavelength information from the transmitted wavelength number counting unit 14, the transmitted wavelength number information stored in the transmitting-side memory within the transmission light amplifier 11 as the latest (most recent) transmitted wavelength number information when “OK flag” is received from the opposing node, i.e., the second node 20. That is, the transmission light amplifier 11 retains the latest value and does not update the value of, for example, the output level of the transmission light amplifier 11. Further, the transmission light amplifier 11 sends to a user an alarm indicating reception of “NG flag”, i.e., an alarm indicating a mismatch between the transmitted wavelength number in the own node, i.e., the first node 10, and the received wavelength number in the opposing node, i.e., the second node 20.

When the alarm indicating “NG flag” is sent from the transmission light amplifier 11, it is assumed that failure has occurred in the transmitted wavelength number counting unit 14 of the own node, i.e., the first node 10, or in the received wavelength number counting unit 28 of the opposing node, i.e., the second node 20. Accordingly, the user performs a maintenance operation such as replacement of the transmitted wavelength number counting unit 14 in the first node 10 or the received wavelength number counting unit 28 in the second node 20.

Transfer of the transmitted wavelength number from the first node 10 to the second node 20 and feedback transfer of the flag (“OK flag” or “NG flag”) from the second node 20 to the first node 10 have been described above by way of example. In the case of opposite direction, i.e., in the case of transfer of the transmitted wavelength number from the second node 20 to the first node 10 and feedback transfer of the flag (“OK flag” or “NG flag”) from the first node 10 to the second node 20, the operation is carried out in the same manner.

As described in detail above, in the wavelength division multiplex device of FIG. 1, which shows an exemplary embodiment of the present invention, not only the wavelength division multiplex device disposed on the upstream side, i.e., the transmitted wavelength number counting unit 4 disposed in the upstream node, but the wavelength division multiplex device disposed at the downstream side, i.e., the received wavelength number counting unit 8, is also disposed in the downstream node as a wavelength number detecting function. Further, the wavelength number information comparison unit 9 compares the transmitted wavelength number information sent from the upstream node to the downstream node with the received wavelength number information detected by the received wavelength number counting unit 8 in the downstream node itself.

Only when the comparison result of the wavelength number information comparison unit 9 shows a match, the output of the reception light amplifier 5, for example, is controlled based on the wavelength number newly detected as the matching transmitted wavelength number information or received wavelength number information. On the other hand, when the comparison result of the wavelength number information comparison unit 9 shows a mismatch, the alarm notifying “NG flag” which indicates the mismatch is sent to the reception light amplifier 5 in the downstream node itself. At the same time, “NG flag” is also sent to the upstream node as a wavelength number mismatch alarm from the monitoring light transmission unit 3 through the multiplexing unit 2. In this manner, each of the reception light amplifier 5 of the downstream node and the transmission light amplifier 1 of the upstream node is notified of the mismatch between the wavelength numbers detected as a result of comparison by the wavelength number information comparison unit 9, by using “NG flag”. Thus, in both the downstream node and the upstream node, the output of the reception light amplifier 5 of the downstream node and the output of the transmission light amplifier 1, for example, are controlled based not on the new wavelength number included in the present wavelength multiplex signal, but on the latest (most recent) wavelength number when the wavelength numbers match as a result of comparison by the wavelength number information comparison unit 9 of the downstream node. This prevents the output of the reception light amplifier 5 of the downstream node and the output of the transmission light amplifier 1 of the upstream node, for example, from being erroneously controlled based on false wavelength number information detected by the transmitted wavelength number counting unit 4.

This situation is typically subdivided into the following two cases: the case where a failure occurring in the transmitted wavelength number counting unit 4 on the upstream node side can be detected by the upstream node itself; and the case where the failure cannot be detected by the upstream node itself. Accordingly, in this exemplary embodiment, as described above, the downstream node having received the wavelength multiplex signal from the upstream node also counts the number of wavelengths of the received wavelength multiplex signal, and checks whether the transmitted wavelength number information notified from the upstream node is correct or not.

That is, as described above with reference to FIG. 2, in the second node 20 located at the downstream side, when the transmitted wavelength number information, which is notified from the upstream-side first node 10, matches the received wavelength number information, which is obtained in the received wavelength number counting unit 28 by counting the number of wavelengths of the wavelength multiplex signal (main signal) received by the second node 20, as a result of comparison between the wavelength numbers by the wavelength number information comparison unit 29, “OK flag” indicating the match and the transmitted wavelength number information that matches the received wavelength number information are output to the reception light amplifier 25. The reception light amplifier 25 updates the received transmitted wavelength number information as the latest transmitted wavelength number information and stores it in the receiving-side memory. At the same time, the reception light amplifier 25 controls the output level of the received wavelength multiplex signal, for example, based on the transmitted wavelength number information.

Further, the wavelength number information comparison unit 29 outputs “OK flag” also to the monitoring light transmission unit 23. The monitoring light transmission unit 23 having received “OK flag” from the wavelength number information comparison unit 29 returns “OK flag”, which is included in the monitoring light signal, to the upstream-side first node 10 via the multiplexing unit 22. In the upstream-side first node 10 having received “OK flag” from the downstream-side second node 20, the transmission light amplifier 11 determines that the transmitted wavelength number information from the transmitted wavelength number counting unit 14 of the own node is correct, updates the transmitted wavelength number information as the latest transmitted wavelength number information to be stored in the transmitting-side memory, and controls the output level of the wavelength multiplex signal to be transmitted, for example, based on the transmitted wavelength number information.

On the other hand, in the comparison between the wavelength numbers by the wavelength number information comparison unit 29, when the transmitted wavelength number information notified from the upstream-side first node 10 does not match the received wavelength number information obtained in the received wavelength number counting unit 28 by counting the number of wavelengths of the wavelength multiplex signal (main signal) received by the second node 20, “NG flag” is output to the reception light amplifier 25 to prohibit updating of the receiving-side memory in the reception light amplifier 25. As a result, the reception light amplifier 25 performs a control based not on the transmitted wavelength number information for which “NG flag” is set, but on the transmitted wavelength number which is held in the receiving-side memory as the latest transmitted wavelength number information when “OK flag” is received from the wavelength number information comparison unit 29.

Furthermore, the wavelength number information comparison unit 29 outputs “NG flag” also to the monitoring light transmission unit 23. The monitoring light transmission unit 23 having received “NG flag” from the wavelength number information comparison unit 29 returns “NG flag”, which is included in the monitoring light signal, to the upstream-side first node 10 via the multiplexing unit 22. In the upstream-side first node 10 having received “NG flag” from the downstream-side second node 20, the transmission light amplifier 11 determines that there is a possibility that the transmitted wavelength number from the transmitted wavelength number counting unit 14 of the own node has an error, and prohibits updating of the transmitting-side memory in the transmission light amplifier 11. As a result, the transmission light amplifier 11 performs a control based not on the transmitted wavelength number information for which “NG flag” is set, but on the transmitted wavelength number which is held in the transmitting-side memory as the latest transmitted wavelength number information when “OK flag” is returned from the downstream-side second node 20.

In the wavelength division multiplex transmission system described above with reference to FIG. 2, in the downstream-side second node 20, when the transmitted wavelength number information notified from the upstream-side first node 10 matches the counted received wavelength number information obtained in the received wavelength number counting unit 28 by counting the wavelength multiplex signal received by the second node 20, as a result of comparison between the wavelength numbers by the wavelength number information comparison unit 29 in the downstream-side second node 20, the wavelength number information comparison unit 29 outputs “OK flag” indicating a match between the transmitted wavelength number information and the reception wavelength number information also to the monitoring light transmission unit 23. Further, the monitoring light transmission unit 23 returns “OK flag”, which is included in the monitoring light signal, to the upstream-side first node 10 via the multiplexing unit 22. However, when the transmitted wavelength number information matches the received wavelength number information in the comparison by the wavelength number information comparison unit 29, it is not necessary to send “OK flag” from the downstream-side second node 20 to the upstream-side first node 10. In the case where the transmitted wavelength number information matches the received wavelength number information, even if the upstream-side first node 10 has not received “OK flag”, the transmission light amplifier 11 determines that the transmitted wavelength number information supplied from the transmitted wavelength number counting unit 14 of the own node is correct. The transmitted wavelength number information is updated as the latest transmitted wavelength number information and stored in the transmitting-side memory so that the output level of the wavelength multiplex signal to be transmitted, for example, can be controlled based on the transmitted wavelength number information. In this manner, in the case where the transmitted wavelength number information matches the received wavelength number information in the comparison by the wavelength number information comparison unit 29, when the transmitted wavelength number information does not match the received wavelength number information in the comparison by the wavelength number information comparison unit 29 in a system in which “OK flag” is not sent from the downstream-side second node 20 to the upstream-side first node 10, “NG flag” is sent from the downstream-side second node 20 to the upstream-side first node 10 as described above. The transmission light amplifier 11 of the first node 10 determines that there is a possibility that the transmitted wavelength number information from the transmitted wavelength number counting unit 14 of the own node has an error, and prohibits updating of the transmitting-side memory in the transmission light amplifier 11. Then, the transmission light amplifier 11 controls the output level, for example, based not on the transmitted wavelength number information for which “NG flag” is ser, but on the transmitted wavelength number held in the transmitting-side memory as the latest transmitted wavelength number information obtained immediately before “NG flag” is returned from the downstream-side second node 20.

The second node 20 located at the downstream of the wavelength division multiplex transmission system described above with reference to FIG. 2 can compare the wavelength number information (transmitted wavelength number information) transmitted from the upstream-side first node 10 with the wavelength number information (reception wavelength number information) detected from the received wavelength multiplex signal by the downstream-side second node 20 itself. In the second node 20 as described above, when a mismatch between the wavelength numbers is detected as a result of comparison between the wavelength numbers in the second node 20 and when “NG flag” is output from the wavelength number information comparison unit 29, even in a system in which the “NG flag” is not supplied to the upstream-side first node 10 but only to the reception light amplifier 25 of the own node, the output of the reception light amplifier 25 in the second node 20, for example, is controlled based on the latest (most recent) wavelength number obtained immediately before “NG flag” is supplied, i.e., based on the preceding wavelength number information, thereby preventing a control error of at least the reception light amplifier 25 of the own node. Moreover, it is possible to send to a user an alarm indicating a mismatch between the transmitted wavelength number extracted from the monitoring light signal, which is superimposed on the wavelength multiplex signal received by the second node 20, and the received wavelength number obtained by counting the received wavelength number of the wavelength multiplex signal in the second node 20.

In the upstream-side first node 10 of the wavelength division multiplex transmission system described above with reference to FIG. 2, the demultiplexing unit 16 receives the wavelength multiplex signal transmitted from the downstream-side second node 20 and demultiplexes the wavelength multiplex signal into the main signal and the monitoring light signal, and the monitoring light reception unit 17 having received the monitoring light signal extracts “NG flag” included in the monitoring light signal, and supplies the “NG flag” to the transmission light amplifier 11. At this time, determining that there is a possibility that the transmitted wavelength number from the transmitted wavelength number counting unit 14 of the own node has an error, the transmission light amplifier 11 having received “NG flag” prohibits updating of the transmitting-side memory in the transmission light amplifier 11. The transmission light amplifier 11 controls the transmission output based not on the transmitted wavelength number information (transmitted wavelength number information for which “NG flag” is set) sent from the transmitted wavelength number counting unit 14, but on the transmitted wavelength number held in the transmitting-side memory as the latest transmitted wavelength number information obtained before “NG flag” is returned from the second node 20 of the downstream side. The output control by the transmission light amplifier 11 as described above can be carried out when “NG flag” is received from the downstream-side node, regardless of whether the comparison result of the wavelength number information comparison unit 19 in the own node 10 shows a match or not.

### (Description of Advantageous Effects of Exemplary Embodiment)

As described in detail above, according to the exemplary embodiment described above, the following effects can be obtained. That is, in the exemplary embodiment described above, the two opposing wavelength division multiplex devices are provided with not only the transmitted wavelength number counting units 14 and 24, which count the number of the transmitted wavelength number of the transmitted wavelength multiplex signal, in the opposing devices located on the upstream side, i.e., the upstream nodes 10 and 20, but also the received wavelength number counting units 28 and 18, which count the received wavelength number of the received wavelength multiplex signal in the opposing devices located at the downstream side, i.e., the downstream nodes 20 and 10. Further, the transmitted wavelength number information in the upstream node and the received wavelength number information in the downstream node are compared to check if they match. When they do not match, an alarm indicating that an abnormality occurs in the operation of counting the wavelength number is sent to facilitate detection of a failure in the transmitted wavelength number counting units 14 and 24 and the received wavelength number counting units 28 and 18. Further, when the comparison result shows a mismatch, “NG flag” is transferred to the transmission light amplifiers 11 and 21 and the reception light amplifiers 25 and 15 to prohibit loading of abnormal wavelength number information, thereby preventing a control error of the transmission light amplifiers 11 and 21 and the reception light amplifiers 25 and 15.

### (Other Exemplary Embodiment)

Next, an exemplary embodiment different from the exemplary embodiment described above will be described as other exemplary embodiment of the present invention.

The above exemplary embodiment has illustrated a case where the received wavelength number counting unit 8, which counts the received wavelength number of the received wavelength multiplex signal, and the wavelength number information comparison unit 9, which compares the received wavelength number with the transmitted wavelength number, are newly provided, as the wavelength division multiplex device 100, in addition to the transmitted wavelength number counting unit 4, which counts the transmitted wavelength number of the transmitted wavelength multiplex signal, so as to determine that the count result of one of the two opposing wavelength division multiplex devices, i.e., the transmitted wavelength number of the first node 10 or the received wavelength number of the second node 20, indicates an abnormality. On the other hand, this exemplary embodiment illustrates a case where when another wavelength division multiplex device connected to another path, i.e., another opposing device, exists as the wavelength division multiplex device 100, the wavelength number information on the wavelength multiplex signal transmitted to and received from the other opposing device connected to the another path is also used to discriminate which one of the count results of the transmitted wavelength number of the first node 10 and the received wavelength number of the second node 20 is abnormal.

Specifically, for example, upon receiving “NG flag” from the opposing device, which is a transmission destination of the wavelength multiplex signal, i.e., the second node 20, the first node 10 having transmitted the transmitted wavelength number of the wavelength multiplex signal to the second node 20 can discriminate which one of the transmitted wavelength number of the own device, i.e., the first node 10, and the received wavelength number of the opposing device, i.e., the second node 20, has an abnormality, based on whether “NG flag” is received also from the opposing device, which is the transmission destination of the another path when the wavelength multiplex signal is transmitted to the another path from the first node 10. The details thereof are as follows.

When “NG flag” is received also from the opposing device, which is the transmission destination of the wavelength multiplex signal through the another path, it is possible to determine that the transmitted wavelength number detected by the own device, i.e., the first node 10, has an abnormality. Then, the opposing device, which is a transmission source of “NG flag” previously received, i.e., the second node 20, is notified of an abnormality in the received wavelength number counted by the opposing device, i.e., the second node. Further, an alarm indicating that the transmitted wavelength number detected by the own device, i.e., the first node 10, has an abnormality is sent to the user.

On the other hand, when “NG flag” is not received also from the opposing device, which is the transmission destination of the wavelength multiplex signal transmitted to the another path, it is possible to determine that the received wavelength number counted by the opposing device, which is the transmission source of “NG flag” previously received, i.e., the second node 20, has an abnormality. Then, the opposing device, i.e., the second node 20, is notified of an abnormality in the received wavelength number counted by the opposing device, i.e., the second node 20.

Further, when the transmitted wavelength number from the opposing device, which is the transmission source of the wavelength multiplex signal, i.e., the first node 10, does not match the received wavelength number counted by the received wavelength number counting unit 28 of the own device, i.e., the second node 20, as a result of comparison by the wavelength number information comparison unit 29, the second node 20 which receives the wavelength multiplex signal from the first node 10 and in which the received wavelength number is counted by the received wavelength number counting unit 28 compares the wavelength number notified from the opposing device in the another path as the wavelength number of the wavelength multiplex signal received from the opposing device in the another path with the count result of the received wavelength number counting unit 28 of the own device, i.e., the second node 20. This makes it possible to discriminate which one of the received wavelength number in the own device showing a mismatch, i.e., the second node 20, and the transmitted wavelength number in the opposing device, i.e., the first node 10. The details thereof are as follows.

When the result of comparison between the wavelength number notified from the opposing device in the another path as the wavelength number of the wavelength multiplex signal received from the opposing device in the another path and the count result of the received wavelength number counting unit 28 of the own device, i.e., the second node 20, shows a mismatch, it is possible to determine that the count result (received wavelength number) of the received wavelength number counting unit 28 of the own node, i.e., the second node 20, has an abnormality. Then, when “NG flag” indicating the mismatch between the transmitted wavelength number and the received wavelength number is not returned to the opposing device, which is the transmission source of the wavelength multiplex signal previously received, i.e., the first node 10, or when “NG flag” has already been returned, “OK flag” indicating that the transmitted wavelength number from the opposing device, i.e., the first node 10, is normal is further notified. Furthermore, an alarm indicating that the received wavelength number counted by the received wavelength number counting unit 28 of the own device, i.e., the second node 20, has an abnormality is sent to the user.

On the other hand, when the result of comparison between the wavelength number notified from the opposing device in the another path as the wavelength number of the wavelength multiplex signal received from the opposing device in the another path and the count result of the received wavelength number counting unit 28 of the own device, i.e., the second node 20, shows a match, it is possible to determine that the transmitted wavelength number from the opposing device, which is the transmission source of the wavelength multiplex signal previously received, i.e., the first node 10, has an abnormality. Further, the opposing device, which is the transmission source of the wavelength multiplex signal previously received, i.e., the first node 10, is notified of an abnormality in the transmitted wavelength number from the opposing device, i.e., the first node 10.

As further another exemplary embodiment, the two opposing wavelength division multiplex devices, i.e., the first node 10 and the second node 20, may also be configured as follows. That is, in addition to the wavelength number information comparison unit 29 disposed in the downstream-side opposing device, i.e., the second node 20, an upstream-side wavelength number information comparison unit may also be disposed in the upstream-side opposing device, i.e., the upstream-side node 10. Further, not only a flag (“OK flag” or “NG flag”) indicating the comparison result of the wavelength number information comparison unit 29, but also the received wavelength number information counted by the received wavelength number count 27 of the downstream-side opposing device, i.e., the second device 20 may also be returned as the information to be fed back to the upstream-side opposing device, i.e., the upstream-side node 10, from the upstream-side opposing device, i.e., the second node 20.

In this configuration, in the upstream-side opposing device, i.e., the upstream node 10, the upstream-side wavelength number information comparison unit compares the information on the transmitted wavelength number counted by the transmitted wavelength number counting unit 14 with the received wavelength number information returned from the downstream-side opposing device, i.e., the second node 20. This makes it possible to check whether “OK flag” or “NG flag”, which is returned from the downstream-side opposing device, i.e., the second node 20, is normal. Moreover, it is also possible to determine the presence or absence of an abnormality in the comparison means itself, such as the wavelength number information comparison unit 19 which compares the wavelength number information, and the wavelength number information comparison unit 29.

The configurations of exemplary embodiments of the present invention have been described above. However, the above embodiments are for illustration only, and the present invention is not limited thereto. As understood by those skilled in the art, the present invention can be modified in various manners depending on the specific application without departing from the scope of the present invention. For example, exemplary embodiments of the present invention can be expressed in various configurations as follows, in addition to the configurations (1), (5), (11), (12), and (16) described in the “Solution to Problem” section. The following items (2)-(4), (6)-(10), (13)-(15), and (17)-(20) respectively correspond to the numbers of claims.

(2) The wavelength division multiplex device set forth in the above item (1), in which when a result of the comparison by the wavelength number information comparison means shows a mismatch, an output level of the received wavelength multiplex signal is controlled based on a latest wavelength number obtained when the transmitted wavelength number and the received wavelength number match each other.

(3) The wavelength division multiplex device set forth in the above item (1) or (2), in which when a result of the comparison by the wavelength number information comparison means shows a mismatch, a flag indicating the mismatch between the transmitted wavelength number and the received wavelength number is transmitted to a device of a transmission source of the wavelength multiplex signal.

(4) The wavelength division multiplex device set forth in the above item (2) or (3), in which when a result of the comparison by the wavelength number information comparison means shows a mismatch, an alarm indicating the mismatch between the transmitted wavelength number in the opposing device of a transmission source and the received wavelength number in an own device is sent to a user.

(6) The wavelength division multiplex device set forth in the above item (5), in which upon the extraction of the flag by the monitoring light receiving means, an alarm indicating the mismatch between the transmitted wavelength number transmitted by the own device and the received wavelength number received by the reception device is sent to a user.

(7) The wavelength division multiplex device set forth in the above item (3) or (4), in which the monitoring light receiving means extracts a flag indicating a mismatch between the transmitted wavelength number transmitted by an own device and the received wavelength number received by a reception device, from monitoring light superimposed on the received wavelength multiplex signal, and upon the extraction of the flag by the monitoring light receiving means, an output level of a wavelength multiplex signal to be transmitted is controlled based on a transmitted wavelength number obtained immediately before the extraction of the flag.

(8) The wavelength division multiplex device set forth in the above item (7), in which upon the extraction of the flag by the monitoring light receiving means, an alarm indicating the mismatch between the transmitted wavelength number transmitted by the own device and the received wavelength number received by the reception device is sent to a user.

(9) The wavelength division multiplex device set forth in the above item (7) or (8), in which when the NG flag is received from a first opposing device which is a transmission destination of the wavelength multiplex signal, it is determined which one of the transmitted wavelength number in the own device and the received wavelength number in the first opposing device has an abnormality, based on whether or not the NG flag has also been received from a second opposing device which is a transmission destination of the wavelength multiplex signal through another path.

(10) The wavelength division multiplex device set forth in any one of the above items (1) to (9), in which when the transmitted wavelength number and the received wavelength number from the opposing device of a transmission source of the wavelength multiplex signal match each other as a result of the comparison by the wavelength number information comparison means, the transmitted wavelength number is updated and stored as a latest transmitted wavelength number in a receiving-side memory, and an output level of the received wavelength multiplex signal is controlled based on the transmitted wavelength number.

(13) The wavelength multiplex signal control method set forth in the above item (12), in which when a result of the comparison shows a mismatch between the received wavelength number and the transmitted wavelength number, an output level of the received wavelength multiplex signal is controlled based on a latest wavelength number obtained when the transmitted wavelength number and the received wavelength number match each other.

(14) The wavelength multiplex signal control method set forth in the above item (12) or (13), in which when a result of the comparison shows a mismatch between the received wavelength number and the transmitted wavelength number, a flag indicating the mismatch between the transmitted wavelength number and the received wavelength number is transmitted to a device of a transmission source of the wavelength multiplex signal.

(15) The wavelength multiplex signal control method set forth in the above item (13) or (14), in which when a result of the comparison shows a mismatch between the received wavelength number and the transmitted wavelength number, an alarm indicating the mismatch between the transmitted wavelength number in the opposing device of a transmission source and the received wavelength number in an own device is sent to a user.

(17) The wavelength multiplex signal control method set forth in the above item (16), in which upon the extraction of the flag, an alarm indicating the mismatch between the transmitted wavelength number transmitted by the own device and the received wavelength number received by the reception device is sent to a user.

(18) The wavelength multiplex signal control method set forth in the above item (14) or (15), including: extracting a flag indicating a mismatch between the transmitted wavelength number transmitted by an own device and the received wavelength number received by a reception device, from monitoring light superimposed on the received wavelength multiplex signal; and controlling, upon the extraction of the flag, an output level of a wavelength multiplex signal to be transmitted, based on a transmitted wavelength number obtained immediately before the extraction of the flag.

(19) The wavelength multiplex signal control method set forth in the above item (18), in which upon the extraction of the flag, an alarm indicating the mismatch between the transmitted wavelength number transmitted by the own device and the received wavelength number received by the reception device is sent to a user.

(20) The wavelength multiplex signal control method set forth in the above item (18) or (19), in which when the NG flag is received from a first opposing device which is a transmission destination of the wavelength multiplex signal, it is determined which one of the transmitted wavelength number on the own device side and the received wavelength number on the first opposing device side has an abnormality, based on whether or not the NG flag has also been received from a second opposing device which is a transmission destination for transmitting the wavelength multiplex signal to another path.

The present invention has been described above with reference to exemplary embodiments, but the present invention is not limited to the above exemplary embodiments. The present invention can be modified in configuration and details in various manners which can be understood by those skilled in the art within the scope of the invention.

Although the present invention is explained as a hardware configuration in the above exemplary embodiments, the present invention is not limited thereto. The present invention can also be implemented by causing a central processing unit (CPU) to execute arbitrary processing as a computer program. In this case, a computer program can be provided in a form stored in a recording medium, or can be provided in a form transmitted via the Internet or other communication media. Examples of storage media include flexible disks, hard disks, magnetic disks, magneto-optical disks, CD-ROMs, DVDs, ROM cartridges, RAM memory cartridges with battery backup, flash memory cartridges, and non-volatile RAM cartridges. Examples of communication media include wired communication media including telephone lines, and wireless communication media such as microwave links.

This application is based upon and claims the benefit of priority from Japanese patent application No. 2009-067354, filed on Mar. 19, 2009, the disclosure of which is incorporated herein in its entirety by reference.

### INDUSTRIAL APPLICABILITY

The present invention is applicable to a wavelength division multiplex device, a wavelength division multiplex transmission system, and a wavelength multiplex signal control method.

### REFERENCE SIGNS LIST

100 WAVELENGTH DIVISION MULTIPLEX DEVICE
1 TRANSMISSION LIGHT AMPLIFIER
2 MULTIPLEXING UNIT
3 MONITORING LIGHT TRANSMISSION UNIT
4 TRANSMITTED WAVELENGTH NUMBER COUNTING UNIT
5 RECEPTION LIGHT AMPLIFIER
6 DEMULTIPLEXING UNIT
7 MONITORING LIGHT RECEPTION UNIT
8 RECEIVED WAVELENGTH NUMBER COUNTING UNIT
9 WAVELENGTH NUMBER INFORMATION COMPARISON UNIT
10 FIRST NODE
10A UPSTREAM NODE
11 TRANSMISSION LIGHT AMPLIFIER
12 MULTIPLEXING UNIT
13 MONITORING LIGHT TRANSMISSION UNIT
14 WAVELENGTH NUMBER COUNTING UNIT (TRANSMITTED WAVELENGTH NUMBER COUNTING UNIT)
15 RECEPTION LIGHT AMPLIFIER
16 DEMULTIPLEXING UNIT
17 MONITORING LIGHT RECEPTION UNIT
18 RECEIVED WAVELENGTH NUMBER COUNTING UNIT
19 WAVELENGTH NUMBER INFORMATION COMPARISON UNIT
20 SECOND NODE
20A DOWNSTREAM NODE
21 TRANSMISSION LIGHT AMPLIFIER
22 MULTIPLEXING UNIT
23 MONITORING LIGHT TRANSMISSION UNIT
24 TRANSMITTED WAVELENGTH NUMBER COUNTING UNIT
25 RECEPTION LIGHT AMPLIFIER
26 DEMULTIPLEXING UNIT
27 MONITORING LIGHT RECEPTION UNIT
28 RECEIVED WAVELENGTH NUMBER COUNTING UNIT
29 WAVELENGTH NUMBER INFORMATION COMPARISON UNIT
30 TRANSMISSION PATH
31 TRANSMISSION PATH
32 TRANSMISSION PATH
33 TRANSMISSION LIGHT AMPLIFIER
34 MULTIPLEXING UNIT
35 MONITORING LIGHT TRANSMISSION UNIT
36 WAVELENGTH NUMBER COUNTING UNIT
45 RECEPTION LIGHT AMPLIFIER
46 MULTIPLEXING UNIT
47 MONITORING LIGHT RECEPTION UNIT
48 TRANSMISSION PATH

1. A wavelength division multiplex device comprising:
received wavelength number counting unit for counting the number of wavelengths of a main signal of a received wavelength multiplex signal as a received wavelength number;
monitoring light receiving unit for extracting information on a transmitted wavelength number from a monitoring light signal superimposed on the received wavelength multiplex signal; and
wavelength number information comparison unit for comparing the transmitted wavelength number with the received wavelength number.

2. The wavelength division multiplex device according to claim 1, wherein when a result of the comparison by the wavelength number information comparison unit shows a mismatch, an output level of the received wavelength multiplex signal is controlled based on a latest wavelength number obtained when the transmitted wavelength number and the received wavelength number match each other.

3. The wavelength division multiplex device according to claim 1, wherein when a result of the comparison by the wavelength number information comparison unit shows a mismatch, a flag indicating the mismatch between the transmitted wavelength number and the received wavelength number is transmitted to a device of a transmission source of the wavelength multiplex signal.

4. The wavelength division multiplex device according to claim 2, wherein when a result of the comparison by the wavelength number information comparison unit shows a mismatch, an alarm indicating the mismatch between the transmitted wavelength number in an opposing device of a transmission source and the received wavelength number in an own device is sent to a user.

5. A wavelength division multiplex device comprising:
monitoring light receiving unit for extracting a flag indicating a mismatch between a transmitted wavelength number transmitted by an own device and a received wavelength number received by a reception device, from monitoring light superimposed on a received wavelength multiplex signal,
wherein upon the extraction of the flag by the monitoring light receiving unit, an output level of a wavelength multiplex signal to be transmitted is controlled based on a transmitted wavelength number obtained immediately before the extraction of the flag.

6. The wavelength division multiplex device according to claim 5, wherein upon the extraction of the flag by the monitoring light receiving unit, an alarm indicating the mismatch between the transmitted wavelength number transmitted by the own device and the received wavelength number received by the reception device is sent to a user.

7. The wavelength division multiplex device according to claim 3, wherein
the monitoring light receiving unit extracts a flag indicating a mismatch between the transmitted wavelength number transmitted by an own device and the received wavelength number received by a reception device, from monitoring light superimposed on the received wavelength multiplex signal, and
upon the extraction of the flag by the monitoring light receiving unit, an output level of a wavelength multiplex signal to be transmitted is controlled based on a transmitted wavelength number obtained immediately before the extraction of the flag.

8. The wavelength division multiplex device according to claim 7, wherein upon the extraction of the flag by the monitoring light receiving unit, an alarm indicating the mismatch between the transmitted wavelength number transmitted by the own device and the received wavelength number received by the reception device is sent to a user.

9. The wavelength division multiplex device according to claim 7, wherein when a NG flag is received from a first opposing device which is a transmission destination of the wavelength multiplex signal, it is determined which one of the transmitted wavelength number in the own device and the received wavelength number in the first opposing device has an abnormality, based on whether or not the NG flag has also been received from a second opposing device which is a transmission destination of the wavelength multiplex signal through another path.

10. The wavelength division multiplex device according to claim 1, wherein when the transmitted wavelength number and the received wavelength number from the opposing device of a transmission source of the wavelength multiplex signal match each other as a result of the comparison by the wavelength number information comparison unit, the transmitted wavelength number is updated and stored as a latest transmitted wavelength number in a receiving-side memory, and an output level of the received wavelength multiplex signal is controlled based on the transmitted wavelength number.

11. A wavelength division multiplex transmission system comprising wavelength division multiplex devices according to claim 1, wherein a wavelength multiplex signal is transmitted between the wavelength division multiplex devices.

12. A wavelength multiplex signal control method comprising:
counting the number of wavelengths of a main signal of a received wavelength multiplex signal as a received wavelength number;
extracting information on a transmitted wavelength number from a monitoring light signal superimposed on the received wavelength multiplex signal;
comparing the received wavelength number with the transmitted wavelength number; and
using a result of the comparison to control the received wavelength multiplex signal.

13. The wavelength multiplex signal control method according to claim 12, wherein when a result of the comparison shows a mismatch between the received wavelength number and the transmitted wavelength number, an output level of the received wavelength multiplex signal is controlled based on a latest wavelength number obtained when the transmitted wavelength number and the received wavelength number match each other.

14. The wavelength multiplex signal control method according to claim 12, wherein when a result of the comparison shows a mismatch between the received wavelength number and the transmitted wavelength number, a flag indicating the mismatch between the transmitted wavelength number and the received wavelength number is transmitted to a device of a transmission source of the wavelength multiplex signal.

15. The wavelength multiplex signal control method according to claim 13, wherein when a result of the comparison shows a mismatch between the received wavelength number and the transmitted wavelength number, an alarm indicating the mismatch between the transmitted wavelength number in an opposing device of a transmission source and the received wavelength number in an own device is sent to a user.

16. A wavelength multiplex signal control method comprising:
extracting a flag indicating a mismatch between a transmitted wavelength number transmitted by an own device and a received wavelength number received by a reception device, from monitoring light superimposed on a received wavelength multiplex signal; and
controlling, upon the extraction of the flag, an output level of a wavelength multiplex signal to be transmitted, based on a transmitted wavelength number obtained immediately before the extraction of the flag.

17. The wavelength multiplex signal control method according to claim 16, wherein upon the extraction of the flag, an alarm indicating the mismatch between the transmitted wavelength number transmitted by the own device and the received wavelength number received by the reception device is sent to a user.

18. The wavelength multiplex signal control method according to claim 14, comprising:
extracting a flag indicating a mismatch between the transmitted wavelength number transmitted by an own device and the received wavelength number received by a reception device, from monitoring light superimposed on the received wavelength multiplex signal; and
controlling, upon the extraction of the flag, an output level of a wavelength multiplex signal to be transmitted, based on a transmitted wavelength number obtained immediately before the extraction of the flag.

19. The wavelength multiplex signal control method according to claim 18, wherein upon the extraction of the flag, an alarm indicating the mismatch between the transmitted wavelength number transmitted by the own device and the received wavelength number received by the reception device is sent to a user.

20. The wavelength multiplex signal control method according to claim 18, wherein when the NG flag is received from a first opposing device which is a transmission destination of the wavelength multiplex signal, it is determined which one of the transmitted wavelength number in the own device and the received wavelength number in the first opposing device has an abnormality, based on whether or not the NG flag has also been received from a second opposing device which is a transmission destination of the wavelength multiplex signal through another path.
